(19) United States
(12) Patent Application Publication
(10) Pub. No.: US 2005/0067581 A1
(43) Pub. Date: Mar. 31, 2005

(54) Method of determining the background corrected counts of radiation quanta in an x-ray energy spectrum

(75) Inventors: Klaus Berhke, Almelo (NL); Hendrik Johannes Jan Bolk, Bornerbroek (NL); Georges Charles Petronella Zieltjens, Almelo (NL)

Correspondence Address: US Philips Corporation;Intellectual Property Department, P.O. Box 3001, Briarcliff Manor, NY, 10510, US

(73) Assignee: Koninklijke Philips Electronics N.V, NL-5621 BA Eindhoven (NL)

(21) Appl. No.: 10/499,464

(22) PCT Filed: Nov. 14, 2002
(86) PCT No.: PCT/IB02/04817

(30) Foreign Application Priority Data
Dec. 20, 2001 (EP) 01205042.3

(51) Int. Cl. G01T 1/00

(52) U.S. Cl. 250/395

(57) ABSTRACT

The invention relates to a method of determining the background-corrected counts of radiation quanta of an X-ray energy spectrum relating to a sample of interest. To this end, two or more different measurement windows are defined in the spectrum. In these windows the counts of radiation quanta are measured and a pair consisting of a first and a second measurement window is selected. A background signal for the first measurement window is calculated on the basis of the counts of radiation quanta in the second measurement window while using a relation defined between said pair of measurement windows. Said background signal is subtracted from the counts of radiation quanta in the first measurement window, thus yielding the background-corrected counts of radiation quanta in the first measurement window. A spectrometer with means for carrying out the steps of the method and a computer program for carrying out the steps of the method are also provided.

A method of determining the background corrected counts of radiation quanta in an X-ray energy spectrum.

The invention relates to a method of determining the background-corrected counts of radiation quanta in an X-ray energy spectrum relating to a sample of interest.

Nowadays various non-destructive techniques are used to analyze (samples of) materials, be it solids, powders or liquids. Wavelength-dispersive X-ray fluorescence spectrometry (WD-XRF) is an example of an X-ray spectrometry technique wherein a sample of interest is irradiated with X-rays causing fluorescence of the sample resulting in a pulse height distribution (PHD) spectrum yielding information about the composition of the sample material. This PHD spectrum is recorded by detector electronics counting the radiation quanta emitted by the sample at a certain angle Θ of an analyzing crystal reflecting the X-ray fluorescence of the sample into the detector positioned precisely at an angle 2θ, twice the crystal angle θ, according to Bragg's law. It is known in the field that in order to obtain reliable information about the sample the corresponding counts should be corrected for the background signal present.

In practice this background correction is performed by what is known as the “background-left-right” method. To this end, for the sample of interest the counts on the left and the right side of a peak of interest in a 2θ spectrum are measured. Based on these measurements the background under the peak can be calculated. This background signal is used in the 2θ measuring position to determine the background-corrected counts.

The known method has several disadvantages. Firstly, for each sample of interest the counts on the peak position as usual and, additionally, on two background positions, have to be measured separately, which is time consuming. Furthermore, the selection of the left and right positions in the 2θ spectrum at which the intensity is to be measured is rather arbitrary and may introduce errors in the calculated background signal and hence in the resultant background-corrected counts.

It is an object of the invention to provide a method of the kind described in the preamble yielding a fast and accurate determination of the background and peak signal present measuring at only one 2θ position

To this end, the method according to the invention is characterized in that it comprises the steps of:
a) defining two or more different measurement windows in the spectrum;
b) measuring the counts of radiation quanta in the measurement windows;
c) selecting a pair consisting of a first and a second measurement window;
d) calculating a background signal for the first measurement window based on the counts of radiation quanta in the second measurement window while using a relation defined between said pair of measurement windows, and
e) subtracting the background signal from the counts of radiation quanta in the first measurement window, yielding the background-corrected counts of radiation quanta in the first measurement window.

The method according to the invention is based on the insight that a relation exists between a pair of measurement windows in an X-ray energy spectrum PHD) of the kind described above, which relation yields information about the background signal present. According to the method of the invention the information present in the PHD itself is used to calculate the background signal. Using the method of the invention makes measuring on separate background positions superfluous, thus effectively shortening measuring time in comparison with the method according to the state of the art.

According to a first preferred version of the method the relation is defined by the following steps:
i) recording an X-ray energy spectrum for a series of blank samples associated with the sample of interest;
ii) performing the steps a, b and c) for each X-ray energy spectrum, yielding a set of corresponding points (x, y) for each selected pair of measurement windows per blank sample, and
iii) fitting a function through the points, said function defining the relation between said pair of measurement windows.

According to this first preferred embodiment the relation between the pair of measurement windows is mathematically determined.

In a second preferred version the background signal in the first measurement window can be accurately calculated as the outcome of the function when the count of radiation quanta in the second measurement window is filled in as a variable.

In order to obtain reliable results the positions of the first and second measurement windows should be suitably chosen. The following three versions are intended as a general guidance and will in many instances be useful in practice. In the first illustrative version the first measurement window is essentially centered around the energy of interest of the sample of interest. In the second version the second measurement window is essentially centered around a multiplicity of the energy of interest of the sample of interest. In the third version the first and second measurement windows of one pair are adjacently situated in the spectrum.

The invention also relates to a radiation analysis apparatus provided with means to carry out the steps of the method according to the invention.

The invention also relates to a computer program for carrying out the steps of the method according to the invention.

The invention will be further illustrated with reference to the following figures:

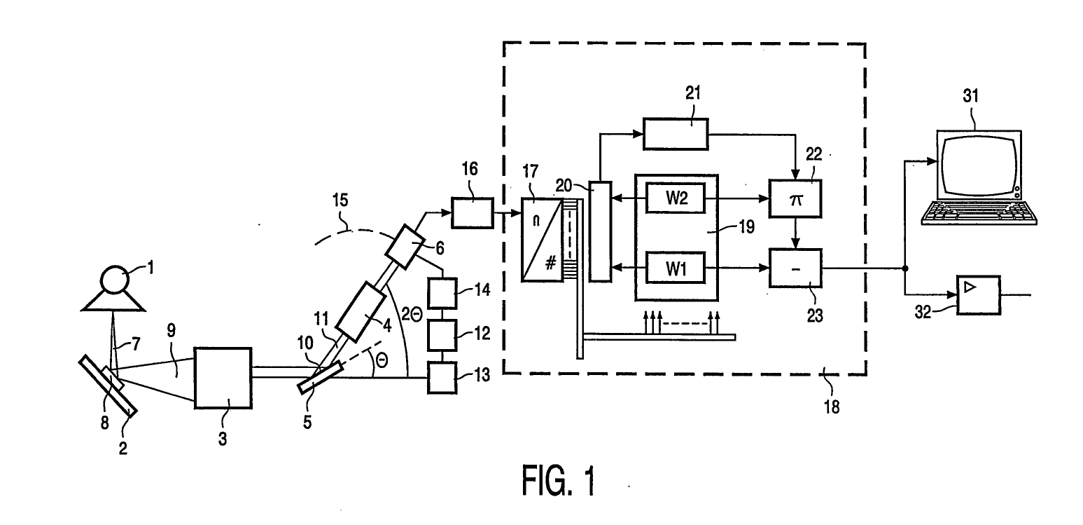

FIG. 1 shows an embodiment of a radiation analysis apparatus according to the invention;

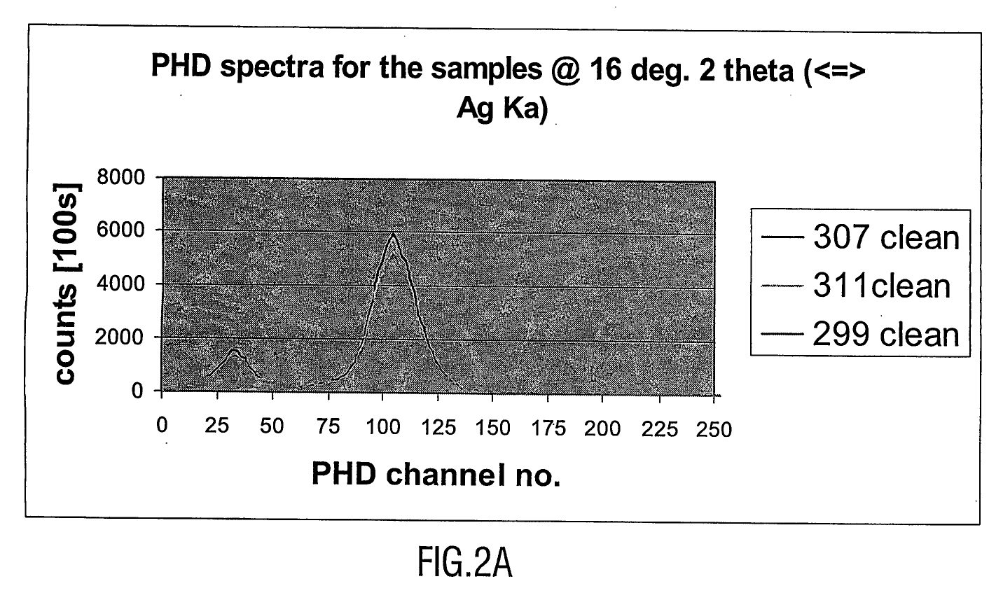

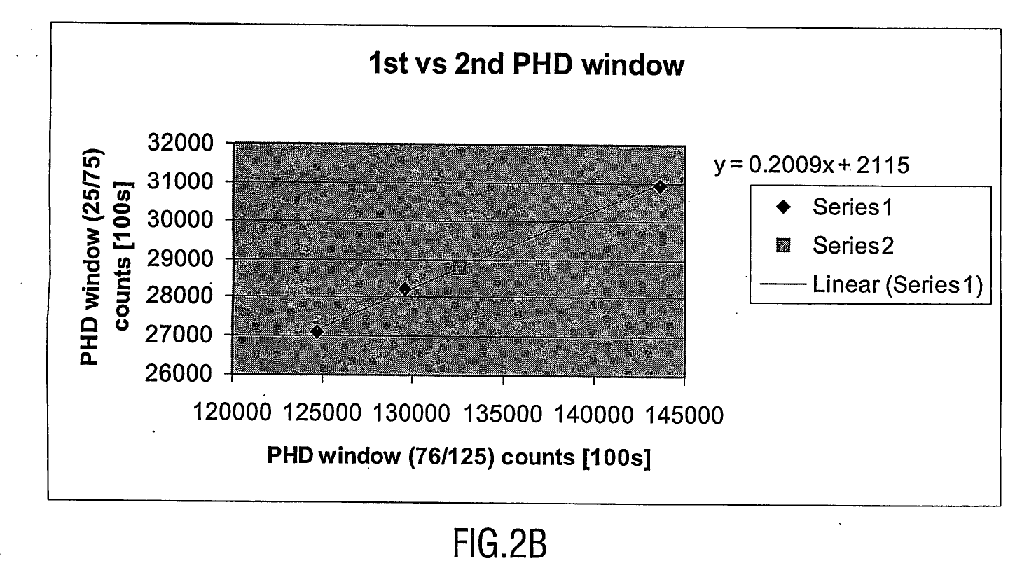

FIG. 2A shows PHD spectra associated with three samples of diverse Cu-based alloys;

FIG. 2B shows the relation between a pair of measurement windows for the samples of FIG. 2A;

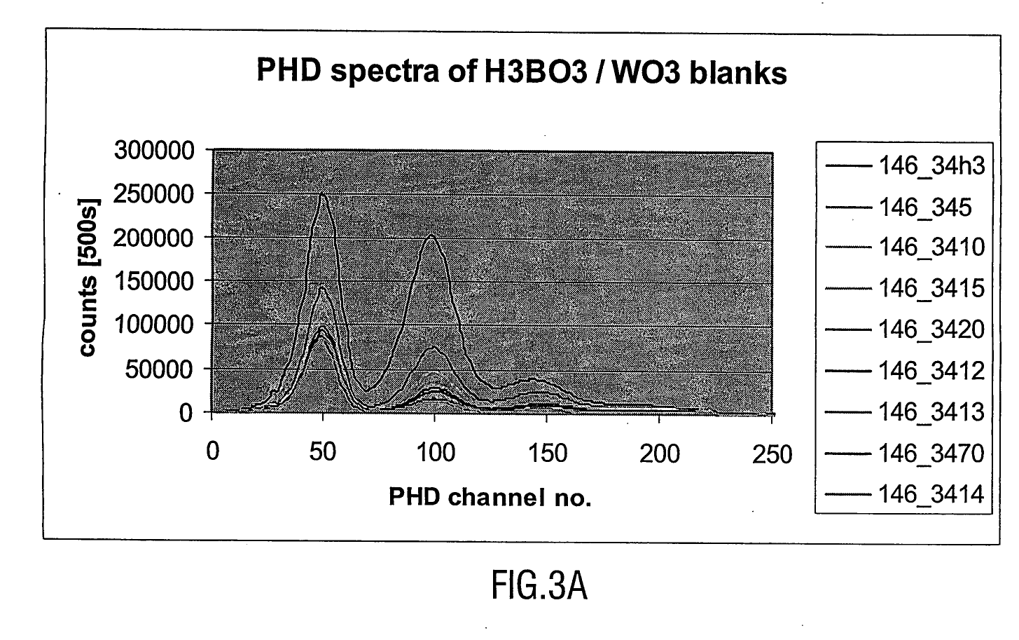

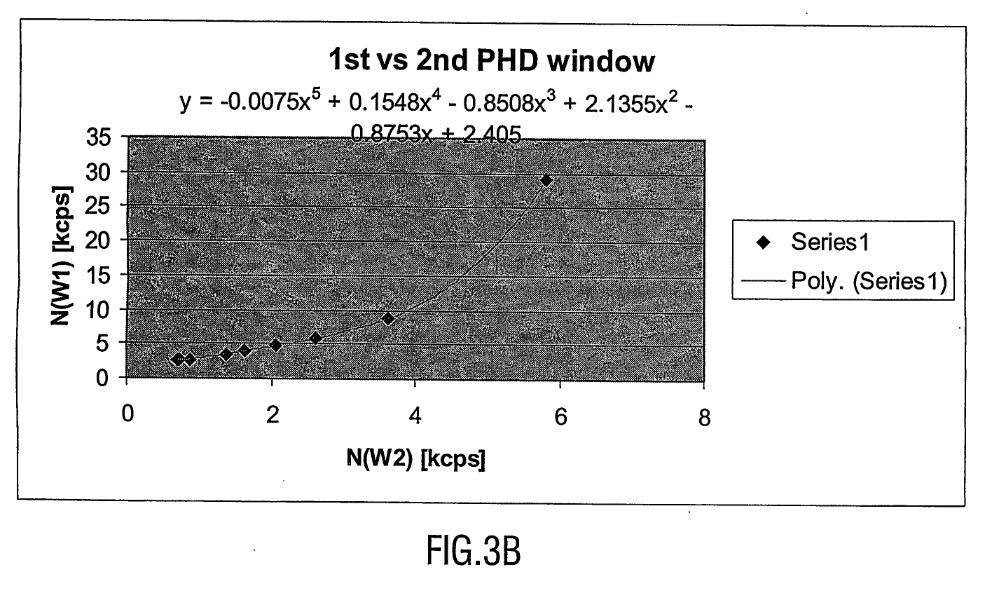

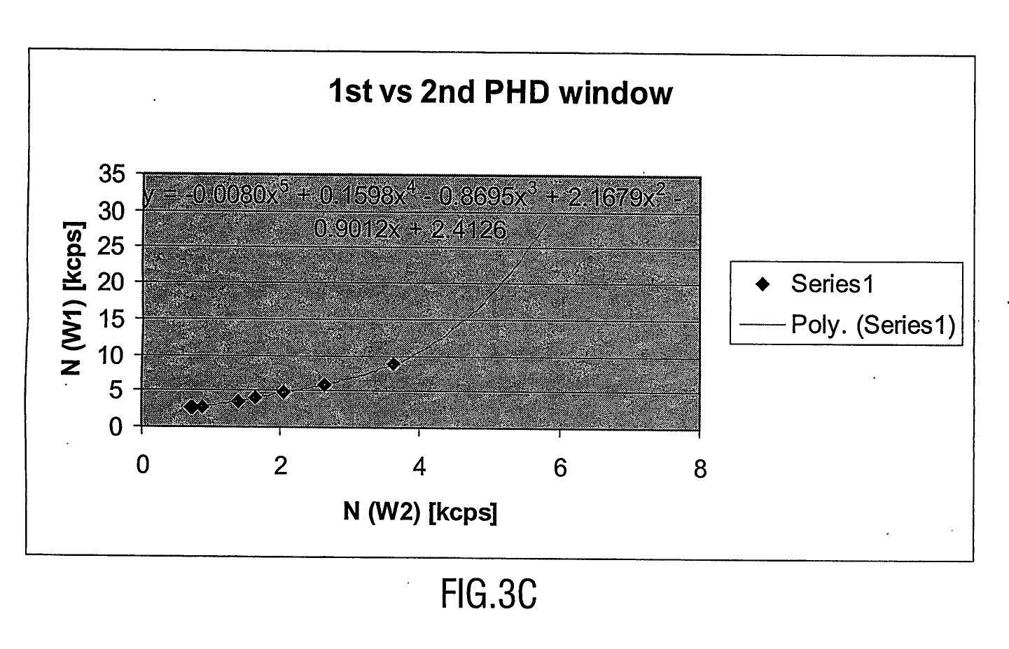

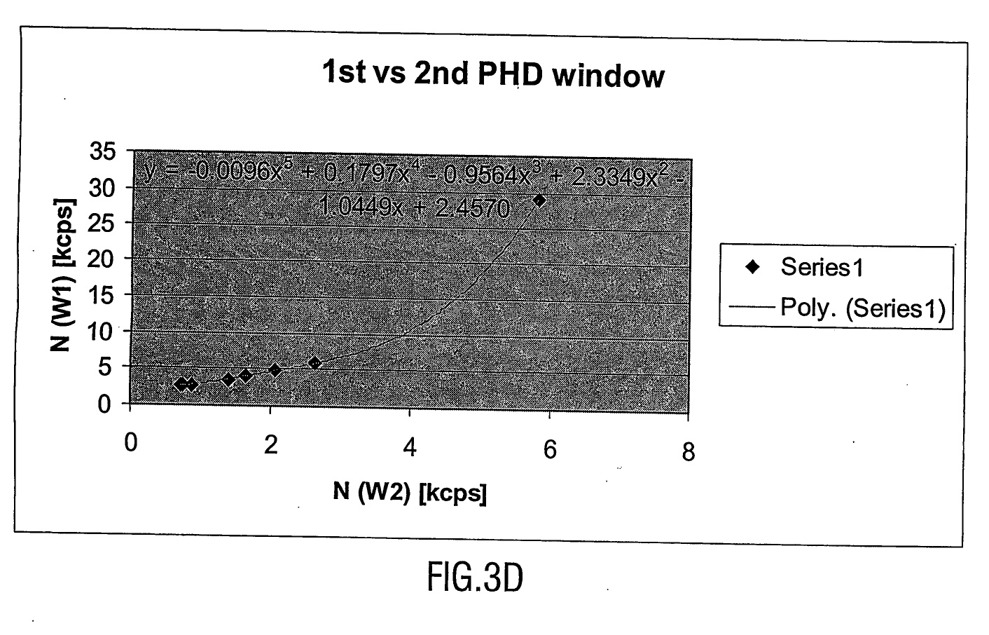

FIG. 3A shows PHD spectra associated with nine samples of diverse H3BO3-based and WO3-based alloys;

FIG. 3B shows the relation between a pair of measurement windows for the samples of FIG. 3A;

FIG. 3C shows the relation between a pair of measurement windows for a first reduced set selected from the samples of FIG. 3A, and

FIG. 3D shows the relation between a pair of measurement windows for a second reduced set selected from the samples of FIG. 3A.

FIG. 1 shows an embodiment of a radiation analysis apparatus or spectrometer provided with means for carrying out the method in accordance with the invention. In fact, the radiation analysis apparatus as shown in FIG. 1 is in particular an X-ray analysis apparatus.

The X-ray analysis apparatus shown in FIG. 1 comprises an X-ray source 1, a sample holder 2, collimators 3 and 4, an analyzing crystal 5 and an X-ray detector 6. Many types of X-ray detectors are suitable for use, such as a gas ionization detector, a scintillation detector, a solid-state detector, etc.

An X-ray beam 7 is incident on a sample 8 and causes X-ray fluorescence to be emitted by the sample. A fluorescence X-ray beam 9 is incident, via the collimator 3, on a surface 10 of the analyzing crystal 5, after which a further X-ray beam 11 reflected therefrom in conformity with Bragg's Law of reflection reaches the X-ray detector 6 via the collimator 4.

A drive motor 12 and a transmission gear 13 rotate over the analyzing crystal at option through an angle θ about an axis perpendicular to the plane of the drawing. The energy of the X-ray beam incident on the X-ray detector is selected within a narrow range by way of this rotation.

The motor 12, acting via a transmission gear 14, causes a rotation of the detector which matches the rotation of the crystal, that is, likewise about an axis at right angles to the plane of drawing. Due to this rotation, the detector is moved along an arc of a circle 15. The settings of the detector angle and the crystal angle are coupled (θ/2θ).

The analog detector signal generated by the detector is controlled by a gain-control circuit 16. Subsequently, said detector signal is converted into a primary digital signal amplitude by an analog-to-digital converter 17. The signal amplitude of the detector signal generated by the detector corresponds to an energy of an X-ray photon incident on the detector. Thus, a distribution of occurrence of amplitudes of signals generated by the detector corresponds to an energy distribution of X-ray photons incident on the detector. Said occurrence distribution of amplitudes of signals will be referred to hereinafter as a pulse-height distribution (PHD) which is displayed on, for example, a cathode-ray tube of a monitor 31 in the form of a histogram. The analog detector signal generated by the radiation detector 6 is processed by detector-reading circuit means 18 that will be further discussed hereinafter.

In order to achieve high-speed operation of the detector-reading circuit, the analog-to-digital converter 17 is a Flash-ADC. A storage circuit having the form of a multi-channel-memory 19, being a part of a multi-channel-analyzer, is provided for converting detector signals generated by the detector into a pulse-height distribution. A channel number of the multi-channel memory corresponds to a narrow range of values for signal amplitudes of detector signal amplitudes generated by the detector, the width of said range being determined by the ratio of a predetermined width of a range of X-ray energies relevant for performing an X-ray analysis to a number of channels of the multi-channel memory. Supplying one primary digital signal to the multi-channel memory has the effect that a value stored in a relevant channel of the multi-channel memory is increased by one unit, the relevant channel being corresponding to the detector signal amplitude generated by the energy of the X-ray quant in the detector. Supplying a sequence of detector signals to the analog-to-digital converter causes a distribution of counts in the multi-channel memory. Analogously, a channel number of the multi-channel memory corresponds to a narrow range of values of energies of X-ray photons detected by the X-ray detector.

According to the invention at least two measurement windows are defined, comprising a part of the available channels with corresponding channel data (counts) stored in the multi-channel-memory 19. In the embodiment of FIG. 1 two measurement windows W1 and W2 are shown, wherein W1 is the measurement window comprising the channels corresponding to energy (or energies) of interest of the sample. This is the window that is usually used in the art. The measurement window W2 is an additional window used by the method according to the invention. The measurement window W2 should differ from W1, but can be chosen freely in dependence on the specific application. Various criteria can be set for the choice of W2, some of which will be discussed later on. The counts of a window are determined by the sum of the counts in the corresponding MCM channels.

In a calibration step, performed prior to an actual analysis, the relation existing between the first and the second measurement windows has to be determined for the sample under analysis. To this end, in memory 20 the counts of windows W2 and W1 of a series of blank samples are stored as calibration data points (x, y), where x corresponds to the PHD window W2 and y to the PHD window W1.

Next a function is fitted through the calibration points representing the relation between W2 and W1. This function (calibration curve) is stored in the memory 21. In FIG. 1 the data flow to the left corresponds to said calibration step that will be discussed in more detail later on.

In FIG. 1 the data flow to the right corresponds to the analysis step. In the calculation means 22 according to the invention the total counts determined in the additional window W2 for the sample under analysis (the unknown sample) are filled in as a variable in the function present in the memory 21. The result of this operation is the background signal present in the measurement window W1.

In the subtraction means 23 this background signal is subtracted from the total counts in the measurement window W1, yielding the background-corrected counts in the measurement window W1 for the sample under analysis.

It is to be noted that the functions performed by the memory means 20, the calibration means 21, the multiplication means 22 and the subtraction means 23, for which separate devices are shown, are performed by computer means being programmed to that end.

First the invention will be illustrated on the basis of the following two examples.

### EXAMPLE 1

In this example the matrix is Cu and Cu/Zn (brass). We analyze the background for the analyte silver (at 2θ=16 degrees). Spectrometer settings are 60 kV/66 mA. A 300 μm brass filter is used. The measuring time for the blanks is 1000 s.

The blanks are Cu-based alloys. The three blanks are samples taken out of three different sub-groups of alloys:

Sample CKD 299: brass Sample CKD 307: Al-bronze Sample CKD 311: Sn-bronze

The associated PHD spectra are shown in FIG. 2A. In the following example an x/y diagram is formed by forming measuring point pairs (x/y)=(N (W2); N (W1)), wherein N denotes the data values (in this case intensity values or total counts) associated with the energies in the window W2 and the window W1, respectively. The diagram for the above three samples is shown in FIG. 2B.

Series 1 contains the x/y points of the three samples and is fitted here by a linear regression, resulting in a background calibration line, by using 1st versus 2nd window intensity (counts/count rates) connection. The resultant function is:
Y=0.20092708*x+2115 (1)

Filling in N(W2) as variable x in formula (1) yields as y value the background signal B(W1) in the window W1 for the associated sample, which in this example is merely the calculated value for N(W1) in the window W1.

The differences between the calculated and measured values are then as follows:

TABLE 1
Background determination by a linear fit.

| | | | B(W1) => | | **Relative | Delta |
|---|---|---|---|---|---|---|
| | | | N(W1) | *Delta | Delta | ***BEC |
| | N (W1) | N (W2) | calc. | [counts] | [%] | [ppm Ag] |
| CKD | 27116 | 124660 | 27163 | +47 | ˜0.17 | +0.5 |
| 299 | | | | | | |
| CKD | 30959 | 143636 | 30975 | +16 | ˜0.05 | +0.15 |
| 307 | | | | | | |
| CKD | 28205 | 129537 | 28142 | −63 | ˜0.22 | −0.6 |
| 311 | | | | | | |

where:
*Delta = N(W1 calc.) − N(W1 meas.)
**Relative Delta = [N(W1 calc.) − N(W1 meas.)]/N(W1 meas.) and
***BEC = background equivalent concentration, with the sensitivity of Ag determined elsewhere for this example during the investigations (and here being about the same for all three samples) amounting to about 105 counts per ppm Ag: BEC [ppm Ag]˜Delta [counts]/105 [counts/ppm Ag]

The arithmetical mean of the differences expressed in BEC [ppm] is for this case:
Delta BEC (blanks fitted)=(0.5+0.15+0.6)ppm/3=1.25/3 ppm=0.42 ppm. (2)

Of course, a calibration is also possible with only one blank. The fit then mathematically reduces to a line through zero. The range of applicability, however, will be reduced, too.

### EXAMPLE 2

The following example applies to strongly varying matrices (with respect to the average atomic weight or average mass absorption) where the background calibration procedure must be even further extended.

For reasons of simplicity we take the matrix system H3BO3+WO3 (from 0% to 75% of WO3, the rest being H3BO3). The mean average mass absorption coefficient μ varies accordingly from about 1 to 55 cm2/g, which is a huge range. Beyond 75% sample preparation was no longer possible. The Rhodium tube settings are 60/66 kV/mA on a 4 kW Philips Magix Pro WD- XRF spectrometer.

No primary beam filter is used. The crystal is LiF (200).

The example shown is taken for the analysis at 2θ=22 degrees. In general the spectrum background shape is strongly bent in the Rh-Compton wavelength region. The angle here is artificially chosen at a position with a relatively bent underground shape. 22 degrees corresponds to approximately 16 keV, being between the Zr Kα and Nb Kα energy. The nine blanks shown in table 3 are used (all without an element peak at 22 degrees.). The blanks have been measured with 500 s each.

TABLE 3

| sample | H3 | W5 | W10 | W15 | W20 | W25 | W50 | W70 | W75 |
|---|---|---|---|---|---|---|---|---|---|
| % WO3 | 0 | 5 | 10 | 15 | 20 | 25 | 50 | 70 | 75 |

Without restriction of generality we use for practical reasons the corresponding count rates (=counts divided by the measuring time) instead of counts for the following example.

FIG. 3A shows the x/y diagram that is formed by forming measuring point pairs (x/y)=(N (W2) ; N (W1)), wherein N denotes the data values, in this case being intensity values, associated with the energies in the window W2 and the window W1, respectively, for the blank samples. The count rate of the first PHD window (25M75) is plotted on the y-axis and the count rate of the second PHD window (76/125) is plotted on the x-axis.

The calculated polynomial (here of degree 5) is displayed within the chart. Under the chart the count rates of the second window (76/125) and there below those of the first window (25/75) are given. The measuring points from left to right contain 75% to 0% WO3 in that order.

This is a set of synthetical samples. We have in this case no real application samples with elements present. Therefore we use some blank samples themselves as unknowns.

In order to determine the background of such a chosen unknown two examples are given.

### EXAMPLE 2A

### Sample H3 as Unknown

We exclude H3 from the blank set and recalculate the polynomial with the rest of the samples. H3 lies far outside the set of the other samples, meaning that in this case an extrapolation has to be performed. The result is shown in FIG. 3C.

The polynomial is calculated with the other eight blanks and extrapolated to the right. The measured count rate of the second PHD window (76/125) of H3 (5.806 kcps) is inserted into the polynomial, giving a calculated value of the background in the first window (25/75) of 28.888 kcps. Compared to the measured value of 29.024 kcps on the sample, the relative deviation is −0.0049 which is 4.9 pro mille (all values rounded).

### EXAMPLE 2B

### Sample WO3_5 as Unknown

Now sample WO3_5 with 5% WO3 is removed from the set of blanks and used as an unknown.2The polynomial is calculated with the remainder of the sample set (the other 8 samples) shown in FIG. 3D.

The newly calculated value for the sample WO3_5 now becomes 8.7695 kcps. Compared to the measured value of 8.7402 kcps the relative deviation is then 0.0033=3.3 pro mille.

The invention teaches that information about the background signal present in a selected measurement window (W1) is present in the data outside of that window. In order to obtain that background information, a second measurement window (W2) has to be selected. It has been found that when the window W2 suitably chosen, which can be performed by any person skilled in the art, a relation providing the background information between the windows W1 and W2 can be established.

The operations described above can be formalized with the following general algorithm:
B(W₁ unknown sample)=F_{{N(W2:W1) set of blanks}}(N(W₂ unknown sample)) (4)
Where

B(Wᵢ, sample j) denotes the background signal in the window Wᵢ for the sample j;

N(Wᵢ, sample j) denotes the counts measured in the window Wᵢ for the sample j, and

F_{{W2: W1 set of blanks}}denotes the fit-function for the x/y data points of {N(W2); N(W1)} of the set of blanks.

In order to find the net count (rate) for the sample j in the window W1 the following operation has to be performed:
N_{background corrected}(W₁unknown sample)=N(W₁unknown sample)−B(W₁unknown sample) (5)

Generally speaking, according to the invention a relation exists between such pairs of measurement windows in an energy spectrum of the type as defined earlier. In a number of practical cases it maybe that a second window contains, in addition to the scatter background, an additional fluorescence peak which is due to a matrix component. In these cases it is often possible to first deconvolute these peaks by an additional energy line overlap calibration or simply by choosing an appropriate other window without such additional interference.

The accuracy of the analysis is dependent on a, the counting statistical error. For the method according to the invention s of the background is diminished, since measuring time is gained as measurement of background on background positions (according to the state of the art) is no longer necessary. The error a can be further reduced as the error term contributed by the subtraction of the background signal can be diminished by measuring the blanks with a long measuring time (e.g.1000 s instead of 100 s). Such a long measuring time can be used in the calibration step, which has to be performed only once prior to the actual measurements of the sample under analysis and, therefore, does not influence the measuring time of the unknown sample necessary to complete the analysis. As a result, the total LLD (Low Limits of Detection) gain may be a factor of up to approximately 2. This LLD value is meant for the determination per sample.

Calibration

During calibration measurements are performed in the same pair of windows, e.g. W2, W1, that is to be used for the actual analysis. A series of blank samples is used yielding a set of calibration points (x, y). Herein the x-values represent data, such as intensity values, measured in W2 and the y-values represent data, such as intensity values, measured in W1. Next a function is fitted through the calibration points representing the relation between W2 and W1. Many suitable fitting techniques are known to the person skilled in the art. The calibration step has to be performed for every specific application of the invention and for every angle Θ of interest of the analyzing crystal.

Criteria

Choice of Blank Samples

Preferably in a blank sample the analyte is absent. It is recognized that as a result the composition of a blank sample differs from that of the sample to be analyzed. The difference may stem inter alia from a different mean atomic weight or effective absorption coefficient (μ) which may give rise to different measurement data (usually intensity values). In the art this different composition is referred to as a different “matrix”.

Matrices may also vary for samples to be analyzed in a specific application. It has been found that when the matrices of the samples for a specific application show only minor variations, the relation between W1 and W2 is very well described by a linear function. When the variations in matrices become greater, the function becomes more complex.

Generally speaking, a sufficient number of blank samples with varying matrices has to be used for calibration in order to cover the expected matrix variation range of the specific application.

Choice of W2

The additional window in a pair, used to correct the other window of that pair (generally referred to as W2) should be suitably chosen by a person skilled in the art. Preferably, W2 should comprise those energies with associated data that most likely result from a phenomenon expected to influence the data in W1. Some examples are additional measurement windows W2, W3, . . . encompassing one or more multiples of the energy associated with the analyte, resulting from higher-order reflections. Additional windows W3, etc. may comprise energies associated with “detector escapes”.

It will be apparent that the choice of W2, W3, . . . will strongly depend on the intended use or application of the invention, but the choice of W2 as (76/125) was found to cover a large range of applications.

Based on the above detailed description of the steps of the method, any person skilled in the art will be able to compose a computer program to carry out the steps of the method by using known programming techniques.

Field of Application

The invention is not limited to the described or illustrated embodiment. Although the invention has been described in the context of sequential XRF instruments, its use is certainly not limited thereto. The method according to the invention can, for example, be used very well with XRF instruments (more specifically: simultaneous WD-XRF, sequential WD-XRF, total reflection XRF (TXRF) and/or energy dispersive XRF (ED-XRF instruments)) offering the advantage that the additional background channels thereof become obsolete. The described MCA electronics maybe used as well as scaler (single window) electronics. In the latter case the measurement windows must be measured in sequence. Furthermore, the use of the method is not limited to XRF-applications alone, but can be applied to similar X-ray analyzing techniques such as X-ray diffraction (XRD) applications.

It will be apparent to a person skilled in the art that the method according to the invention is suitable for analyzing samples in which any number of analytes (also known as “major elements” or “majors” in the art) having different associated energies of interest may be present. For illustrative purposes only, the examples described herein refer to a sample with one analyte.

The invention thus extends in general to any embodiment which is within the scope of the appended claims as seen in light of the foregoing description and drawings.

1. A method of determining the background-corrected counts of radiation quanta of an X-ray energy spectrum relating to a sample of interest, characterized in that, it comprises the steps of :
a) defining two or more different measurement windows in the spectrum;
b) measuring the counts of radiation quanta in the measurement windows;
c) selecting a pair consisting of a first and a second measurement window;
d) calculating a background signal for the first measurement window based on the counts of radiation quanta in the second measurement window while using a relation defined between said pair of measurement windows, and
e) subtracting the background signal from the counts of radiation quanta in the first measurement window, yielding the background corrected counts of radiation quanta in the first measurement window.

2. A method according to claim 1, wherein the relation is defined by the following steps:
i) recording an X-ray energy spectrum for a series of blank samples associated with the sample of interest;
ii) performing the steps a, b and c) for each X-ray energy spectrum, yielding a set of corresponding points (x, y) for each selected pair of measurement windows per blank sample, and
iii) fitting a function through the points, said function defining the relation between said pair of measurement windows.

3. A method-according to claim 2, wherein the step d comprises the step of calculating the background signal in the first measurement window as the outcome of the function when the count of radiation quanta in the second measurement window is filled in as a variable.

4. A method according to claim 1, wherein the relation is defined by the following steps:
i) recording an X-ray energy spectrum for at least one blank sample associated with the sample of interest;
ii) performing the steps a, b and c) for each X-ray energy spectrum, yielding a set of corresponding points (x, y) for each selected pair of measurement windows, and
iii) calculating the ratio of the intensity counts in the first and second measurement windows, said ratio defining the relation between the intensity counts in the first and second measurement windows.

5. A method according to claim 4, wherein the step d comprises the step of calculating the background signal in the first measurement window as the counts of radiation quanta in the second measurement window times the ratio.

6. A method according to claim 1, wherein the first measurement window is essentially centered around the energy of interest of the sample of interest.

7. A method according to claim 1, wherein the second measurement window is essentially centered around a multiple of the energy of interest of the sample of interest.

8. A method according to claim 1, wherein the first and second measurement windows of a pair are situated essentially adjacently in the spectrum.

9. A radiation analysis apparatus provided with means for carrying out the steps of the method according to claim 1.

10. A computer program for carrying out the steps of the method according to claim 1.
